(19) United States
(12) Patent Application Publication
(10) Pub. No.: US 2019/0205693 A1
(43) Pub. Date: Jul. 4, 2019

(54) Scale-Invariant Feature Point Extraction in Edge Map

(71) Applicant: MORPHOTRAK, LLC, Anaheim, CA (US)

(72) Inventors: Hui Zhu, Anaheim, CA (US); Peter Zhen-Ping Lo, Mission Viejo, CA (US)

(73) Assignee: MORPHOTRAK, LLC, Anaheim, CA (US)

(21) Appl. No.: 15/857,460

(22) Filed: Dec. 28, 2017

(51) Int. Cl. G06K 9/46

(52) U.S. Cl. CPC G06K 9/4671; G06K 2009/4666; G06K 9/4633

(57) ABSTRACT

Systems and methods may be used to detect scale invariant features in an image. Circle like region points may be detected from a plurality of edge maps produced from a plurality of smoothed images. Edge maps are obtained by taking partial derivatives of multi-scaled smoothed images and the smoothed images might be obtained from down scaled image and convolved with different scaled filters. The strong ridges are kept for circle detection based on the scale-normalized edge strength and direction of the point. A 2-1 Hough Transform is used to detect the circles at the radius as a function of the standard deviation of the filter. Only the strong circle points are kept to calculate the descriptors. Multi descriptors are calculated at the regions around the circle points from a plurality of images. The images might include the smoothed images, the difference of the images and the edge map images.

### FIELD

This disclosure generally relates to image processing systems.

### BACKGROUND

To address the increasing demand for multimedia information such as videos and still images, there is a need for images to be processed, classified, and searched for in a speedy and accurate manner. To accomplish this, existing techniques for detecting objects within images need improvement.

### SUMMARY

Scale invariant features can be used to identify objects in images, and are often used in object recognition, navigation, and image processing applications. An image may contain multiple objects, which can be difficult to differentiate and distinguish particularly if the image quality is poor. One way of differentiating the objects is by extracting feature descriptors of the objects. These feature descriptors can also be utilized to identify the same objects in other images.

In general, when using scale invariant features for object recognition, extrema of intensity and/or corner points are first detected over all scales and locations of an image so that the detected points are scale invariant. Next, a local descriptor may be constructed to represent the interest point in a feature vector. These local feature vector descriptors are used to match between two images for object recognition. However, in some cases, an object in an image may not have a good appearance due to image noise, lighting condition, or other reasons. With such conditions present in an image, intensity extreme points may not be the best way to represent the object.

Implementations in this disclosure address the above-noted shortcomings and disclose methods and systems to detect scale invariant features in an image. A Gaussian-pyramid for an image may be created by applying a Gaussian-blur filter and by down sampling the blurred image. Partial derivatives of the scaled and blurred images in the Gaussian-pyramid may be taken to generate edge maps. Circle like region feature points may be detected from the edge maps based on the scale-normalized edge strength and direction. A 2-1 Hough Transform is adapted to detect the circles having a particular radius range. Descriptors are calculated at the points that have strong circle like edges from the images. The images might include the smoothed images, the difference of the images, and the edge map images.

According to implementations, a computer-implemented method for identifying scale invariant features in an image is disclosed. The method includes receiving an image that includes one or more objects, and generating, by one or more processors, a Gaussian pyramid of the received image. The Gaussian pyramid includes a plurality of octave levels. The method further includes determining, by the one or more processors, one or more edges in each image in each octave level and identifying one or more circle feature points using Hough transform in each image in each octave level. At least one of the one or more identified circle feature points corresponds to at least one of the objects in the image. The method further includes determining, by the one or more processors, a direction and a descriptor for each point for the identified one or more circle feature points and storing, in a memory, the descriptors for all points for the identified one or more circle feature points.

Implementations may each optionally include one or more of the following features. For instance, in some implementations, determining the one or more edges in each image in each octave level includes determining partial derivatives for each image in each octave level, and determining a scale-normalized edge strength and a direction for each point in each image.

In some implementations, the scale-normalized edge strength is normalized based on a derivative order of the partial derivatives and a scale associated with the respective octave level.

In some implementations, determining the one or more edges in each image in each octave level includes determining that one or more respective strengths of the one or more edges along a circle ring satisfy an edge threshold.

In some implementations, radii of one or more circles associated with the identified one or more circle feature points are within a predetermined range.

In some implementations, identifying the one or more circle feature points includes: identifying one or more candidate circle feature points using the Hough transform; for each candidate circle feature point, determining whether a circle associated with the candidate circle feature point has a total number of supportive edge pixels that is greater than a threshold, the threshold being a function of a circumference length of the circle associated with the candidate circle feature point; and selecting a candidate circle feature point that satisfies the threshold as one of the identified one or more circle feature points.

In some implementations, the descriptor for each identified circle feature point is determined based on a local patch, and a size of the local patch is based on a radius of a circle associated with the identified circle feature point.

In some implementations, the direction and the descriptor of an identified circle feature point is determined based on a gradient histogram or a local binary pattern of a local patch in a Gaussian-smoothed image, a Difference of Gaussian Image (DOG), or an edge map image.

Other aspects include corresponding methods, systems, apparatus, computer-readable storage media, and computer programs configured to implement the above-noted embodiments.

The above-noted aspects and implementations further described in this specification may offer several advantages. For example, according to the implementations described in this specification, scale invariant features in an image may be identified by utilizing fewer feature points (less detailed image information required) and greater matched points. This advantage allows the matching time to be significantly reduced and the detected feature points to be less sensitive to noise and more robust for matching.

The details of one or more implementations are set forth in the accompanying drawings and the description below. Other features and advantages will become apparent from the description, the drawings, and the claims.

### BRIEF DESCRIPTION OF THE DRAWINGS

FIG. 1 illustrates an exemplary process for identifying scale invariant features in an image.

FIG. 2 depicts an exemplary Gaussian pyramid implementation.

FIG. 3 depicts exemplary illustrations of detected edges and circle feature points in a sample image.

FIG. 4 illustrates an exemplary system for matching an object in an acquired image to an object in a reference image.

FIGS. 5A and 5B depict exemplary results for matching objects according to implementations described in this disclosure.

FIG. 6 illustrates an exemplary system for identifying scale invariant features in an image.

In the drawings, like reference numbers represent corresponding parts throughout.

### DETAILED DESCRIPTION

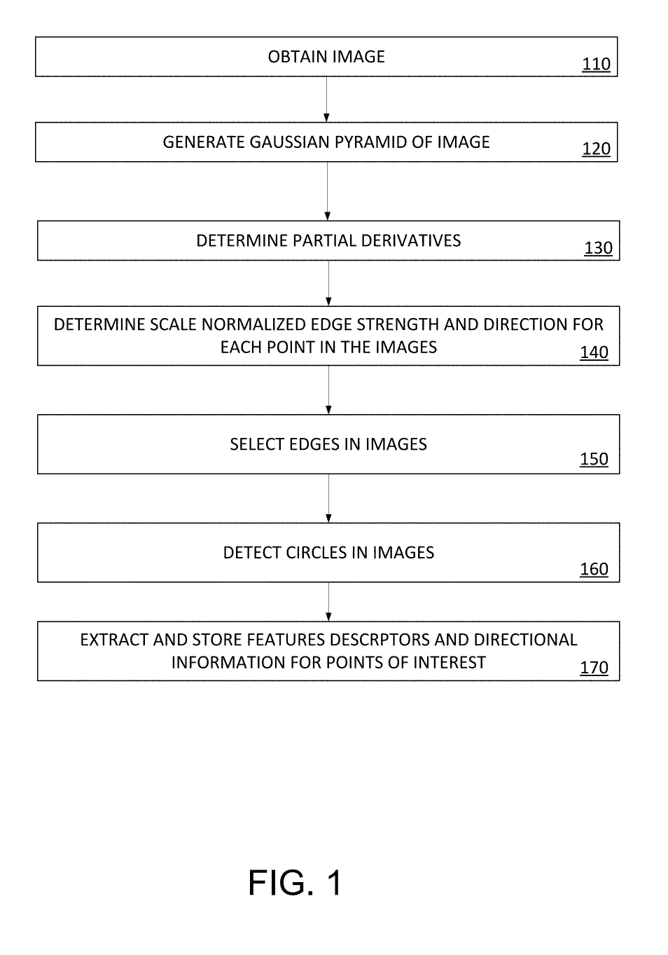

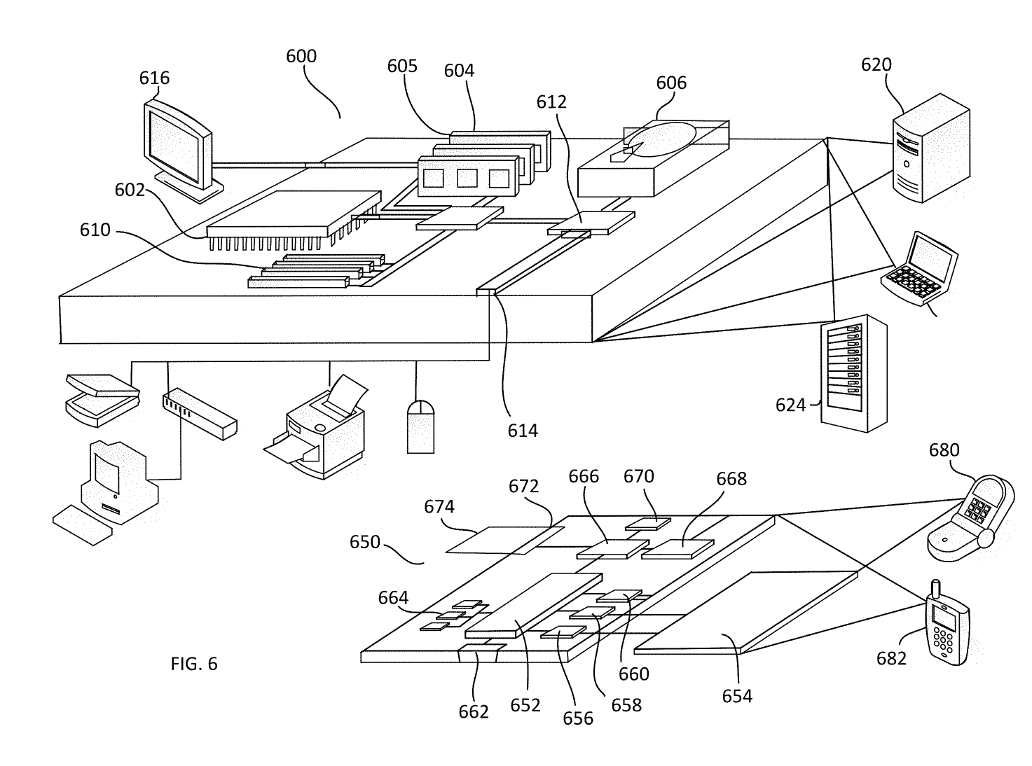

Implementations of the methods and systems for determining and storing scale invariant features in an image are described with reference to FIGS. 1-6. The methods are described as being implemented by a system, which is described further with respect to FIG. 6.

Referring to FIG. 1, a method to identify scale invariant features in an image may be initiated by obtaining an image (110). The image may be obtained by the system through various suitable methods. For example, in some cases, the image may be obtained from an image acquisition device such as a camera or scanner. In some cases, the image may be obtained from a database that stores images.

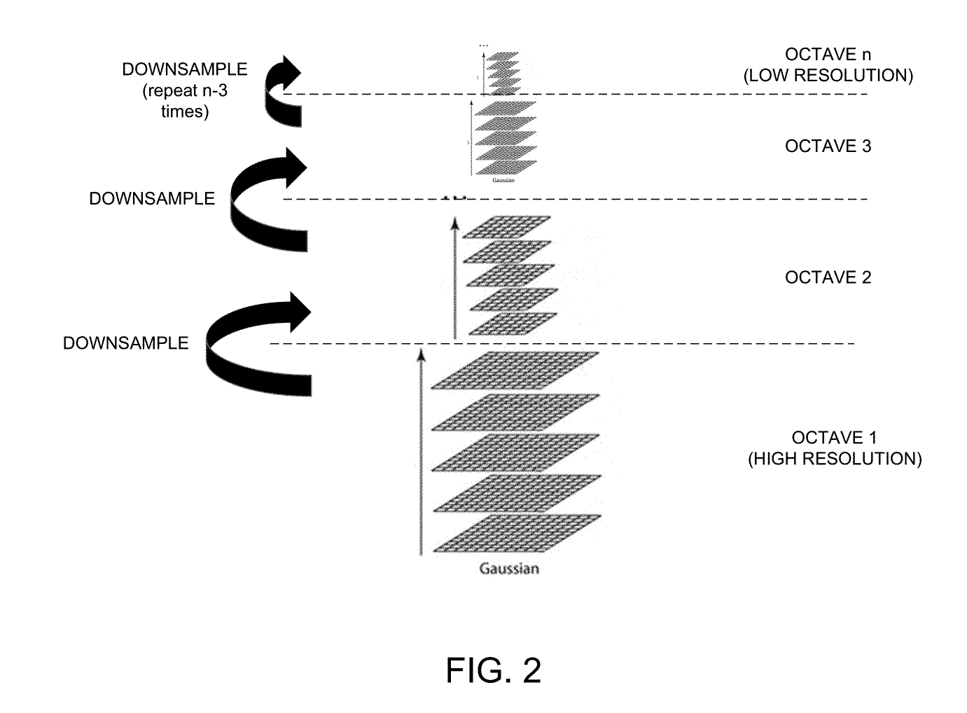

After obtaining the image, the system may generate a Gaussian pyramid, which, in some implementations, may be organized in octaves or octave levels (120). As illustrated in FIG. 2, to generate a Gaussian pyramid, a Gaussian blur or Gaussian smoothing filter may be applied to an image by convolving the image with a Gaussian kernel. The application of a Gaussian blur may have an affect similar to applying a low-pass filter to an image and results in the removal of high frequency components of an image and the blurring or smoothening of the image.

In addition to the application of a Gaussian blur, the image may be down sampled thereby resulting in a smaller sized image. The process of applying a Gaussian blur and down sampling may be repeated multiple times to generate a multi-level pyramid structure as illustrated in FIG. 2. Each level of the pyramid corresponds to an octave level. In the same octave level, a set of filters with different scales may be applied to the images. The same set of filters may be applied to an image in each of the octaves. Accordingly, each octave level may include multiple images that have been filtered or processed differently. Although FIG. 2 depicts each octave level as including five images, in general, any number of images greater than one may be included in each octave level. In some implementations, the images in each octave level are down-sampled by a factor of two relative to the prior octave.

Referring back to FIG. 1, after generating a Gaussian pyramid, the system may determine the partial derivatives with respect to the x-axis and y-axis of each image at each octave level (130). The partial derivatives may include first derivatives or second derivatives. The partial derivatives may provide information regarding the localization of edges in an image. For example, peaks in the first derivatives or zero crossings in the second derivative may be indicative of an edge in an image. Thus, an edge map can be derived from obtaining the partial derivatives.

Based on the partial derivatives, the scale normalized edge strength and direction at each point on an image may be determined (140). As an example, if the partial derivatives are denoted as gₓ and g_{y}, the scale-normalized edge strength may be calculated using Equation 1 below in which a is the Gaussian smoothing parameter for a particular octave level of the Gaussian pyramid.

σ(gₓ²+g_{y}²) [Equation 1]

In some implementations, the scale-normalized edge strength may be normalized based on the order of the derivative used in generating the partial derivative and the scale applied to the image in an octave level. For instance, determined edge strength for points in an image in the first octave level may be normalized differently than the edge strength for points in images in the second octave level. Additionally, the normalized gradient direction ( [symbol] ) may be calculated for each point in an image.

The system may select one or more edges by comparing the calculated normalized edge strength to a particular threshold (150). For example, if the normalized edge strength satisfies (i.e., is greater than or equal to) the particular edge threshold, the system selects the edge point. In this manner, only strong edge points are selected and relied upon for circle feature point detection as described below.

The system may detect one or more candidate circle feature points in the images (160) using various types of circle detection methods. For example, in some implementations, a 2-1 Hough Transform may be used in which a candidate center circle may be identified using a two-dimensional (2-D) accumulator and a radius of the candidate center circle may be determined using a 1-D histogram.

In some implementations, constraints on the size or type of circle may also be implemented. For example, the system may be configured to detect candidate circle feature points that have a particular radius range, e.g., between 2σ and 2σ+3 pixels. Here, σ may refer to the standard deviation of the Gaussian filter applied to the image. In some cases, the radii of the detected candidate circle feature points in all octave levels may be within a particular radius range. For instance, the system may be configured to detect candidate circle feature points having a radius between 12 to 15 pixels or between 8 to 10 pixels.

In some implementations, circle fitting is performed in addition to the Hough transformation. Because several octave levels contain images that have been down sampled relative to images in the previous octave level, candidate circle feature points detected in the high levels of octaves are located on a lower resolution grid. Directly mapping these circle feature point locations and radiuses to the original image resolution may cause errors. Circle fitting helps reduce or eliminate such errors. To execute circle fitting, all the edge points supporting a Hough circle are fitted using various suitable circle-fitting techniques such as a least squares fitting method. The fitted circle has subpixel location coordinates and radius, which can then be interpolated to a higher resolution.

In some implementations, as part of the operation 160 to detect circle feature points, the list of candidate circle feature points may be narrowed down to a list of determined circle feature points using a threshold criterion. For example, a determined circle feature point may be detected if the total number of supportive edge pixels is greater than a threshold that is a function of a circumference length of a circle associated with the candidate circle feature point. For example, if the total number of the supportive edge pixels is more than 70% of the circumference length of a circle associated with the candidate circle feature point, the candidate circle feature point may be designated as a primary feature point and a determined circle feature point. If the total number of the supportive edge pixels is more than 60% but less than or equal to 70% of the circumference length of a circle associated with the candidate circle feature point, the candidate circle feature point may be designated as a secondary feature point and a determined circle feature point. By utilizing this additional threshold, only points that are highly likely to be associated with circles are used to generate local feature descriptors, as described below. By creating two sets of feature points, e.g., primary and secondary feature points, the system may use either set of feature points for matching and achieve a better trade-off between accuracy and speed. For example, in some cases, utilizing the primary set of feature points may provide greater matching accuracy, and, in some cases, utilizing the secondary set of feature points may provide greater speed in executing matching operations. Here, a supportive edge pixel may refer to an edge pixel that is within a circular ring of the radius e.g., between 2σ and 2σ+3 pixels (e.g., 12-15 pixels or 8-11 pixels) associated with a candidate circle feature point.

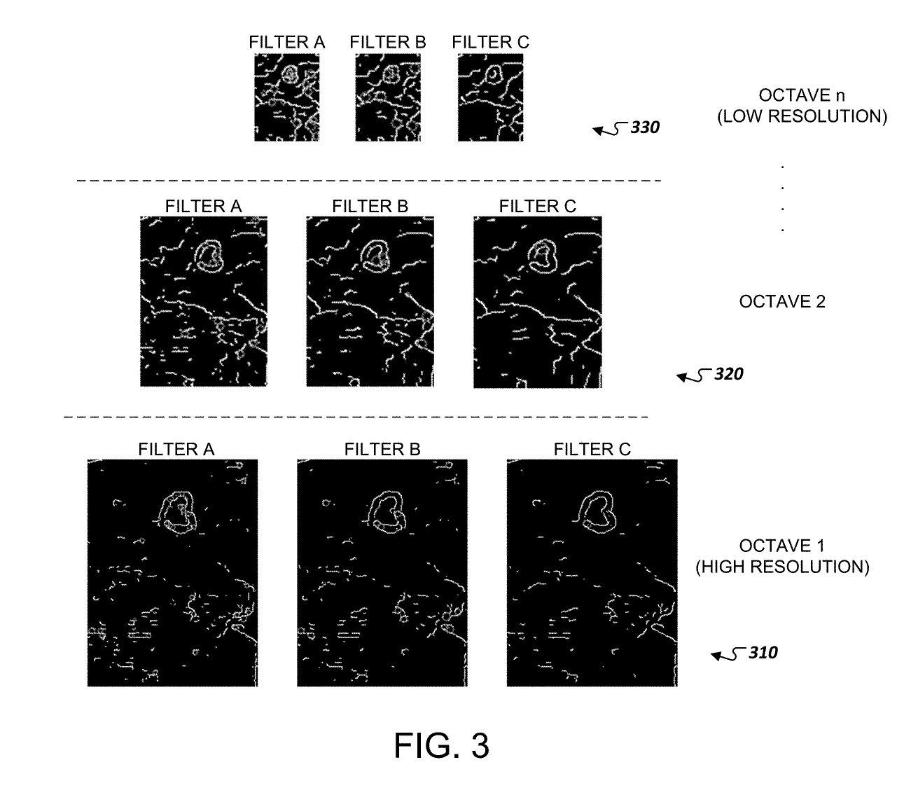

FIG. 3 illustrates exemplary images that include identified edges and determined circle feature points in the different octave levels of the Gaussian pyramid. The octave levels are indicated by row 310, row 320, and row 330. Each row includes images that have been processed by the same set of filters, e.g., filters A, B, and C. Each higher octave level includes images that have been downsized from a prior octave level. For instance, row 320 includes images that have been downsized by a factor of two relative to the images in row 310. Row n includes images that have been downsized by a factor of two*(n−2) relative to the images in row 320. Note that the images in FIG. 3 are not shown proportional to their actual size.

In row 310, circle feature points for images in Octave 1 or a lower level of the Gaussian pyramid are shown. The top half of the images includes a heart-shaped edge with a number of determined circle feature points. The heart-shaped edge corresponds to an image of a heart-shaped tattoo. Note that due to the different filters applied in octave 1, each image in octave 1 includes some of the same determined circle feature points as other images in octave 1 and some different circle feature points that have not been identified in other images in octave 1.

After identifying the determined circle feature points, the system may extract and store directional information and local feature descriptors for various points of interest (170). In some implementations, the points of interest may include only the points associated with the determined circle feature points, such as points along a circumference of a determined circle feature point. This allows the amount of data associated with feature descriptors and images, in general, to be significantly reduced. In some implementations, the points of interest may include points associated with one or more regions around a determined circle feature point, such as pixels next to pixels associated with a circumference of a determined circle feature point. A feature descriptor for a point of interest may be calculated based on a local patch, an area of which may be determined based on the respective radius of a determined circle.

In general, various types of descriptors, such as a Histogram of Oriented Gradients (HOG) or Local Binary Pattern (LBP), may be extracted. In some implementations, the direction and feature descriptor of a point may be determined based on the gradient histogram or LBP of a local patch associated with the point from a Gaussian smoothed image, Difference of Gaussian image (DOG), or edge map.

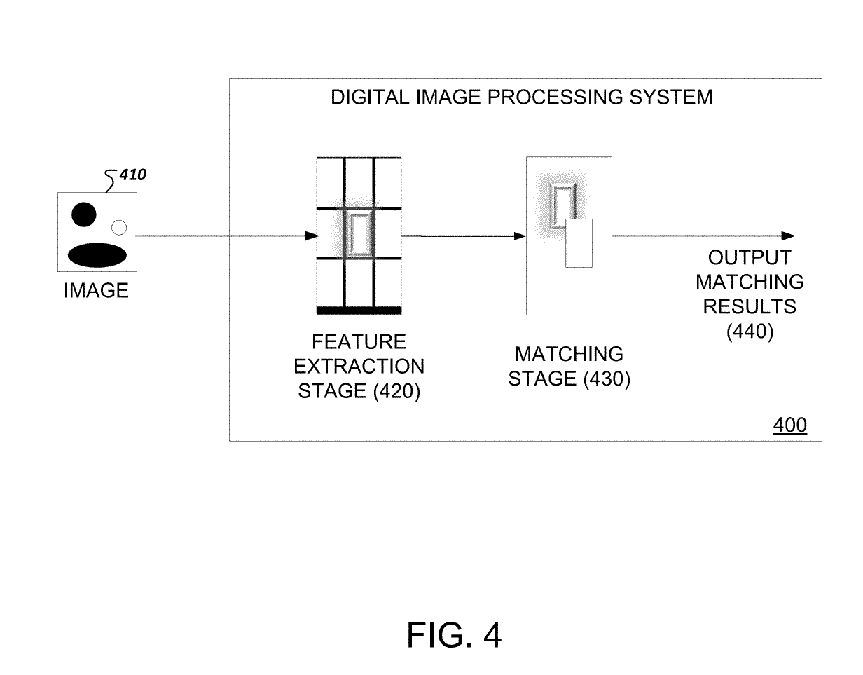

The determined feature descriptors for each point of interest, e.g., determined circle points, may be stored in a system memory. In some cases, the stored feature descriptors may additionally include data such as, for example, directional information, location, or scale information that provides additional descriptive information about a point of interest. The feature descriptors may be referred to by the system when matching objects in two or more images, as described further with respect to FIG. 4.

In FIG. 4, a digital image processing system 400 may receive an image 410 and may process the image 410 in two stages, namely a feature extraction stage (420) and a matching stage (430), before outputting the matching results (440). The image 410 may be received through various suitable means. For example, in some cases, the system 400 may receive the image 410 in the form of an electronic file through electronic communication from another computing device. The communication may be of various types, including, for example, a message such as an e-mail or data transmitted across a wired or wireless network. The other computer device may include, but is not limited to, a computer, laptop, smart phone, electronic pad, server, database, or an image acquisition device, such as a camera or scanner.

After receiving the image, the system 400 may extract the feature descriptors from the received image in the feature extraction stage (420). To extract the feature descriptors, the system 400 may execute the method illustrated in FIG. 1. After obtaining the extracted feature descriptors, the system may store the extracted feature descriptor information in the form of a feature vector, and search one or more databases for feature vectors in one or more reference images that match the feature vectors obtained from image 410 (430). The reference images include previously collected images that are stored in one or more databases and may be used for training or matching purposes.

The matching stage (430) may be executed in one or more steps. For example, in some cases, the system 400 may extract image tags from the received image 410 and compare the extracted image tags to tags of the reference images. If the tags match, the system 400 may execute a subsequent stage of determining whether feature vectors obtained from image 410 match stored feature vectors associated with objects in the reference images that have the same tags as the tags of the received image 410. By initially performing a tag matching step, the number of reference images searched through may be reduced which results in a decrease in the time required to find matches.

In some implementations, the above-noted tag matching step may be omitted, and the system 400 may search for matching feature vectors in reference images. In general, various suitable matching techniques may be used to match feature vectors obtained from image 410 to feature vectors associated with objects in reference images. For example, in some cases, a Best-Bin-First Search method or a Hough transform voting method may be used in the matching stage (430). In general, multiple stage matching strategies, such as local to global and coarse to fine matchings, may be used to execute the matching of feature vectors. The various strategies and techniques may respectively offer a trade-off between matching accuracy and matching speed, and a matching strategy or technique may be selected based on the desired level of accuracy and matching speed. For example, the detected primary descriptor feature vectors may be used to perform a fast search of feature vectors in a reference database to find potential reference matching candidates based on the local features. Then, the primary and/or secondary features' point location and geometrical relationships may be applied to match only to the (local) matched candidate list instead of a whole dataset thereby achieving better matching accuracy and speed.

When one or more matching feature vectors are found, an object similarity score and/or an image similarity score may be determined for each matching image. The object similarity score may indicate a degree of similarity between an object in image 410 and an object in a reference image. The image similarity score may indicate a degree of similarity between the image 410 and the reference image. In some implementations, the values of the similarity scores may range from 0.0 to 1.0, where a higher magnitude represents a greater degree of similarity. The system may compute similarity scores for each feature vector and aggregate similarity scores (or “final similarity scores”) to determine similarity between objects in two images or the overall similarity between two images.

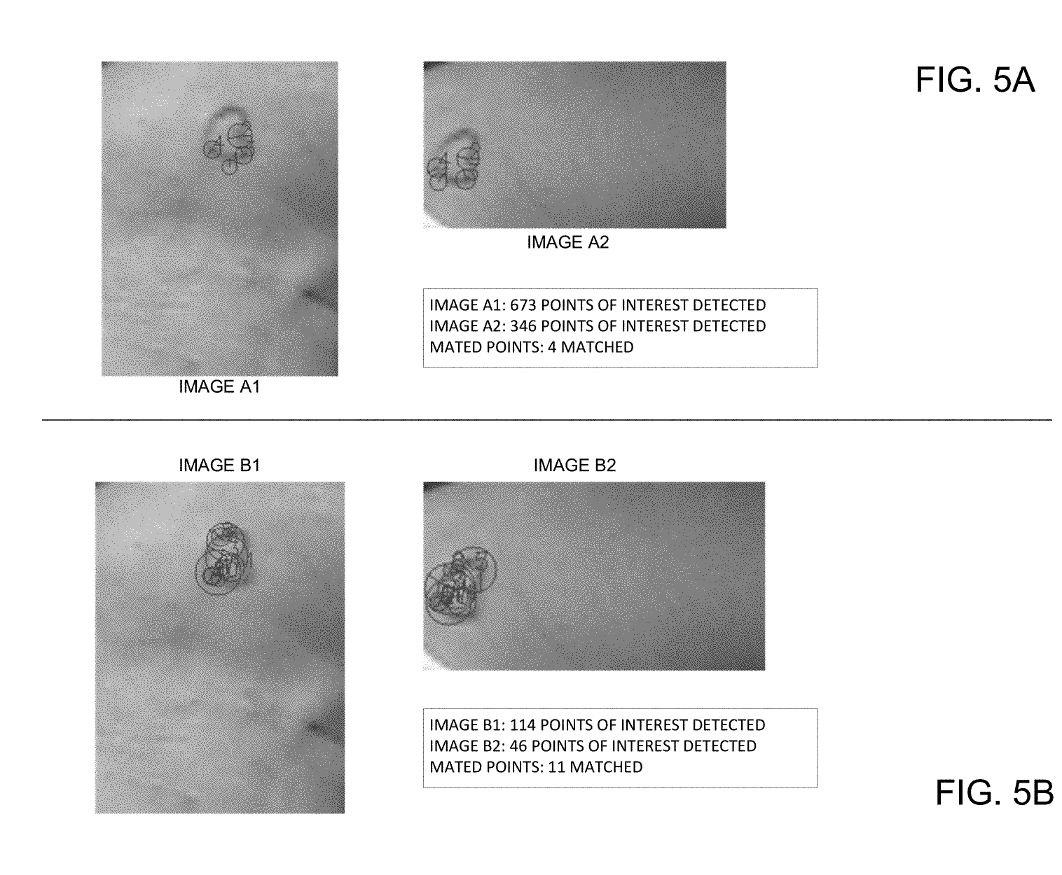

In some implementations, a matching threshold may be utilized, and only matching reference images or objects that have a similarity score that satisfies the matching threshold may be provided as part of the output match results. As shown in FIG. 5B, the results may include a number of points and/or circles identified in image 410 and the matching reference image, and a number of mated or matched points between image 410 and the matching reference image.

FIGS. 5A and 5B depict an example of the improvement and increased utility provided by the implementations disclosed in this disclosure. In FIG. 5A, sample results are provided for matching two separate images, i.e., images A1 and A2, of the same heart shaped tattoo according to a conventional method. Images A1 and A2 may have been obtained in different ways, for example, by virtue of an image acquisition device or a database. As shown in FIG. 5A, 673 points of interest were detected for image A1 and 346 points of interest were detected for image A2 when the conventional method for object detection was utilized. Although there were a large number of points of interest in both images, only 4 points matched.

In comparison, FIG. 5B depicts sample results obtained in matching two separate images, i.e., images B1 and B2, of the same heart shaped tattoo according to the methods disclosed in this disclosure. Images B1 and B2 may have been obtained in a different manner, for example, by virtue of an image acquisition device or a database. As shown in FIG. 5B, 114 points of interest were detected for image B1 and 46 points of interest were detected for image B2. Although a fewer number of points of interest were identified in both images, the number of matching points was 11, which exceeds by more than 300% the number of matched points generated as a result of the conventional method depicted in FIG. 5A. Accordingly, the implementations described in this disclosure advantageously provide methods and systems in which the number of points of interest is reduced, which reduces the computational resources and power needed when processing images and finding matching objects. Additionally, the number of matching points is greater, which demonstrates that the points of interest are more relevant, thereby reducing the chances of false positive detections and false negative omissions.

Embodiments and all of the functional operations and/or actions described in this specification may be implemented in digital electronic circuitry, or in computer software, firmware, or hardware, including the structures disclosed in this disclosure and their structural equivalents, or in combinations of one or more of them. FIG. 6 is a block diagram of computing devices 600, 650 that may be used to implement the implementations described herein. Computing device 600 represents various forms of digital computers, such as workstations, servers, blade servers, mainframes, and other appropriate computers. Computing device 650 represents various forms of user devices, such as personal digital assistants, cellular telephones, smartphones, smart televisions, watches, and other similar computing devices. The components shown here, their connections and relationships, and their functions, are exemplary, and do not limit implementations described herein.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners. The processor 602 can process instructions for execution within the computing device 600, including instructions stored in the memory 604 or on the storage device 606 to display graphical information for a GUI on an external input/output device, such as display 616 coupled to high speed interface 608. In some implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system). In general, the processor 602 may control operations of the computing device 600, and may include various logic circuitry and programs to execute implementations described herein.

The computing device 600 may include one or more classifiers (not shown) that can be trained using reference images. In some implementations, the one or more classifiers may include a neural network and may be configured using rules for detecting objects and generating feature descriptors.

The memory 604 stores information within the computing device 600. In some implementations, the memory 604 may include one or more of a computer-readable medium, a volatile memory unit(s), or a non-volatile memory unit(s).

The storage device 606 is capable of providing mass storage for the computing device 600. In some implementations, the storage device 606 may include one or more mass storage devices, for example, magnetic, magneto optical disks, optical disks, EPROM, EEPROM, flash memory devices, and may be implemented as internal hard disks, removable disks, magneto optical disks, CD ROM, or DVD-ROM disks for storing data. In some implementations, the storage device 606 may include a non-tangible computer-readable storage medium that contains instructions, which when executed, perform one or more methods or portions of the methods described above. In some implementations, the storage device 606 may store rules for determining whether content can be acquired based on one or more parameters provided by a user. In some implementations, the storage device 606 may store a plurality of reference images, tags for the images, and feature descriptors.

The high-speed controller 608 manages bandwidth-intensive operations for the computing device 600, while the low speed controller 612 manages lower bandwidth-intensive operations. Such allocation of duties is exemplary. In some implementations, the high-speed controller 608 is coupled to memory 604, display 616 (e.g., through a graphics processor or accelerator), and to high-speed expansion ports 610, which may accept various expansion cards (not shown). In some implementations, a low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, an image acquisition device such as a camera or scanner, or a networking device such as a switch or router, e.g., through a network adapter.

The computing device 600 may be implemented in a number of different forms, as shown in the figure. For example, computing device 600 may be implemented as a standard server 620, a group of such servers, or as part of a rack server system. The server 620 may be, for example, one or more of a network server, an image sharing or processing server, a content server, and an application server. In some implementations, the computing device 600 may be implemented as a personal computer such as a laptop computer.

In some implementations, the computing device 600 may wirelessly communicate with device 650 over one or more networks to execute one or more operations of the method described in FIG. 1. In some implementations, the computing device 600, when operating as a digital image processor, may receive a request to search for a matching image from device 650 and, in response, may provide the search results that include matching images to device 650.

The one or more networks connecting computing devices 600 and 650 may include access points, storage systems, cloud systems, modules, one or more databases including one or more media databases, and servers including one or more network servers such as computing device 600. The one or more network servers may include any suitable computing device coupled to the one or more networks, including but not limited to a personal computer, a server computer, a series of server computers, a mini computer, and a mainframe computer, or combinations thereof. The one or more network servers may also include an application server, a web server, or a series of servers, running a network operating system, examples of which may include but are not limited to Microsoft® Windows® Server, Novell® NetWare®, or Linux®. The one or more network servers may be used for and/or provide cloud and/or network computing and media provision services. Although not shown in the figures, the server may have connections to external systems providing messaging functionality such as e-mail, SMS messaging, text messaging, and other functionalities, such as advertising services, search services, etc.

In some implementations, the one or more networks may include a cloud system that may provide Internet connectivity and other network-related functions. For example, the cloud system may provide storage services for at least a portion of the data transmitted between components of the system.

The cloud system or one or more networks may also include one or more databases, which may include a media storage database, a media provision database, a cloud database, or a database managed by a database management system (DBMS). A DBMS may be implemented as an engine that controls organization, storage, management, and retrieval of data in a database. DBMSs frequently provide the ability to query, backup and replicate data, enforce rules, provide security, do computation, perform change and access logging, and automate optimization. A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. Data structures can include fields, records, files, objects, and any other applicable known or convenient structures for storing data. A DBMS may also include metadata about the data that is stored.

Computing device 650 may include a processor 652, memory 664, a user interface such as a display 654, a communication interface 666, and a transceiver 668, among other components. Each of the components 650, 652, 664, 654, 666, and 668, may be interconnected using various buses, and several of the components may be mounted on a common motherboard or in other manners as appropriate.

The transceiver 668 may include a transmitter and a receiver and may be utilized to communicate with devices 680, 682 in the one or more networks and components within computing device 650. The transceiver 668 may include amplifiers, modulators, demodulators, antennas, and various other components. The transceiver 668 may direct data received from other external devices, such as servers, databases, portable devices connected to a wireless network, to other components in the computing device 650 such as the processor 652 and memory 664. The transceiver 668 may also direct data received from components in the computing device 650 to external devices.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS receiver module 670 may provide location services and additional wireless data to device 650, which may be used by applications running on device 650.

Memory 664 stores information within the computing device 650, and, in some implementations, may also be coupled to one or more additional storage devices to provide additional storage. The memory 664 may include a computer-readable storage medium or store one or more modules of computer program instructions encoded on a computer-readable storage medium for execution by, or to control the operation of, data processing apparatus. The computer-readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, for example, code that constitutes processor firmware, a protocol stack, a database management system, an operating system, or a combination of one or more of them. A propagated signal is an artificially generated signal, for example, a machine-generated electrical, optical, or electromagnetic signal that is generated to encode information for transmission to suitable receiver apparatus.

A computer program, also known as a program, software, software application, script, plug-in, or code, may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data in a single file dedicated to the program in question, or in multiple coordinated files. A computer program may be deployed to be executed on one computer or on multiple computers that are located at one site or distributed across multiple sites and interconnected by a communication network.

In some implementations, the memory 664 may be a volatile memory unit or units. In some implementations, the memory 664 may be a non-volatile memory unit or units. Expansion memory 674 may also be provided and connected to device 650 through expansion interface 672, which may include, for example, a SIMM card interface. Such expansion memory 674 may provide extra storage space for device 650, or may also store applications or other information for device 650. For example, expansion memory 674 may include instructions to carry out or supplement the processes described above, and may include secure information also. Thus, for example, expansion memory 674 may be provided as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, one or more mass storage devices, for example, magnetic, magneto optical disks, optical disks, EPROM, EEPROM, flash memory devices, and may be implemented as internal hard disks, removable disks, magneto optical disks, CD ROM, or DVD-ROM disks for storing data. In some cases, the memory may store one or more of images, videos, rules for training neural networks, and may include a cache for temporarily storing acquired content.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry, for example, an FPGA (field programmable gate array) or an ASIC (application specific integrated circuit).

Processors suitable for the execution of a computer program include, by way of example, both general and special purpose microprocessors, and any one or more processors of any kind of digital computer. The processor 652 can process instructions for execution within the computing device 650, including instructions stored in the memory 664. The processor may also include separate analog and digital processors. The processor may provide, for example, for coordination of the other components of the device 650, such as control of user interfaces, applications run by device 650, and wireless communication by device 650. Generally, a processor may control operations of the computing device 650, and may include various logic circuitry and programs to execute the various implementations described herein.

Processor 652 may communicate with a user through a user interface that includes a control interface 658 and display interface 656 coupled to a display 654. The display 654 may be implemented through suitable displays including, for example, a projection display, a liquid crystal display (LCD), or light emitting diode (LED) display, to display various data. For example, in some implementations, the display of the user interface 326 may display an image and a matching image provided from computing device 600. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, so as to enable near area communication of device 650 with other devices. External interface 662 may provide, for example, for wired communication (e.g., via a docking procedure) or for wireless communication (e.g., via Bluetooth or other such technologies).

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The audio codec 660 may, in some cases, be connected to or implemented with a microphone or speaker. In some implementations, messages, such as a rejection message indicating that the requested content may not be acquired using the fetching parameter values provided by the user, may be communicated through audio signals emitted from speakers. In some implementations, certain applications, such as speech-to-text applications may be executed by receiving audio or voice signals through the microphone.

Although not shown, computing device may also include sensors and input unit(s). Sensors may include, for example, an optical sensor, capacitive sensor, charge-coupled device sensor, gyroscope, microphone, altimeter, impact sensor, piezoelectric sensor, motion sensor, biosensor, active pixel sensor, and various other sensors. The input unit(s) may include various devices that are configured to receive one or more inputs. For example, the input unit may include a mouse, touch pad, or keyboard for receiving alphanumeric text.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and may even be claimed as such, one or more features from a claimed combination may in some cases, be excised from the combination, and the claimed combination may be directed to a sub-combination or variation of a sub-combination.

Similarly, while actions are depicted in the drawings in a particular order, this should not be understood as requiring that such actions be performed in the particular order shown or in sequential order, or that all illustrated actions be performed, to achieve desirable results. Moreover, the separation of various system components in the embodiments described above should not be understood as requiring such separation in all embodiments, and it should be understood that the described program components and systems may generally be integrated together in a single software product or packaged into multiple software products.

It should be understood that the phrase one or more of and the phrase at least one of include any combination of elements. For example, the phrase one or more of A and B includes A, B, or both A and B. Similarly, the phrase at least one of A and B includes A, B, or both A and B.

Thus, particular implementations have been described. Other implementations are within the scope of the following claims. For example, the actions recited in the claims may be performed in a different order and still achieve desirable results.

What is claimed is:

1. A computer-implemented method to identify scale invariant features in an image, the computer-implemented method comprising:
receiving an image that includes one or more objects;
generating, by one or more processors, a Gaussian pyramid of the received image, the Gaussian pyramid including a plurality of octave levels;
determining, by the one or more processors, one or more edges in each image in each octave level;
identifying one or more circle feature points using Hough transform in each image in each octave level, at least one of the one or more identified circle feature points corresponding to at least one of the objects in the image;
determining, by the one or more processors, a direction and a descriptor for each identified one or more circle feature points; and
storing, in a memory, the descriptors for all identified one or more circle feature points.

2. The computer-implemented method of claim 1, wherein determining the one or more edges in each image in each octave level comprises:
determining partial derivatives for each image in each octave level; and
determining a scale-normalized edge strength and a direction for each point in each image.

3. The computer-implemented method of claim 2, wherein the scale-normalized edge strength is normalized based on a derivative order of the partial derivatives and a scale associated with the respective octave level.

4. The computer-implemented method of claim 1, wherein determining the one or more edges in each image in each octave level comprises:
determining that one or more respective strengths of the one or more edges along a circle ring satisfy an edge threshold.

5. The computer-implemented method of claim 1, wherein radii of one or more circles associated with the identified one or more circle feature points are within a predetermined range.

6. The computer-implemented method of claim 1, wherein identifying one or more circle feature points comprises:
identifying one or more candidate circle feature points using the Hough transform;
for each candidate circle feature point, determining whether a circle associated with the candidate circle feature point has a total number of supportive edge pixels that is greater than a threshold, the threshold being a function of a circumference length of the circle associated with the candidate circle feature point; and
selecting a candidate circle feature point that satisfies the threshold as one of the identified one or more circles.

7. The computer-implemented method of claim 1, wherein:
the descriptor for each identified circle feature point is determined based on a local patch; and
a size of the local patch is based on a radius of a circle associated with the identified circle feature point.

8. The computer-implemented method of claim 1, wherein the direction and the descriptor of a point is determined based on a gradient histogram or a local binary pattern of a local patch in a Gaussian-smoothed image, a Difference of Gaussian Image (DOG), or a edge map image.

9. A system comprising:
one or more processors and one or more storage devices storing instructions that are operable and when executed by one or more processors, cause the one or more processors to perform operations comprising:
receiving an image that includes one or more objects;
generating a Gaussian pyramid of the received image, the Gaussian pyramid including a plurality of octave levels;
determining one or more edges in each image in each octave level;
identifying one or more circle feature points using Hough transform in each image in each octave level, at least one of the one or more identified circle feature points corresponding to the objects in the image;
determining a direction and a descriptor for each point for the identified one or more circle feature points; and
storing, in a memory, the descriptors for all points for the identified one or more circle feature points.

10. The system of claim 9, wherein determining the one or more edges in each image in each octave level comprises:
determining partial derivatives for each image in each octave level; and
determining a scale-normalized edge strength and a direction for each point in each image.

11. The system of claim 10, wherein the scale-normalized edge strength is normalized based on a derivative order of the partial derivatives and a scale associated with the respective octave level.

12. The system of claim 9, wherein determining the one or more edges in each image in each octave level comprises:
determining that one or more respective strengths of the one or more edges satisfy an edge threshold.

13. The system of claim 9, wherein identifying one or more circle feature points comprises:
identifying one or more candidate circle feature points using the Hough transform;
for each candidate circle feature point, determining whether a circle associated with the candidate circle feature point has a total number of supportive edge pixels that is greater than a threshold, the threshold being a function of a circumference length of the circle associated with the candidate circle feature point; and
selecting a candidate circle feature point that satisfies the threshold as one of the identified one or more circle feature points.

14. The system of claim 9, wherein:
the descriptor for each identified circle feature point is determined based on a local patch; and
a size of the local patch is based on a radius of a circle associated with the identified circle feature point.

15. One or more non-transitory computer-readable storage media comprising instructions, which, when executed by one or more processors, cause the one or more processors to perform operations comprising:
receiving an image that includes one or more objects;
generating a Gaussian pyramid of the received image, the Gaussian pyramid including a plurality of octave levels;
determining one or more edges in each image in each octave level;
identifying one or more circle feature points using Hough transform in each image in each octave level, at least one of the one or more identified circle feature points corresponding to the objects in the image;
determining a direction and a descriptor for each point for the identified one or more circle feature points; and
storing, in a memory, the descriptors for all points for the identified one or more circle feature points.

16. The one or more non-transitory computer-readable storage media of claim 15, wherein determining the one or more edges in each image in each octave level comprises:
determining partial derivatives for each image in each octave level; and determining a scale-normalized edge strength and a direction for each point in each image.

17. The one or more non-transitory computer-readable storage media of claim 16, wherein the scale-normalized edge strength is normalized based on a derivative order of the partial derivatives and a scale associated with the respective octave level.

18. The one or more non-transitory computer-readable storage media of claim 15, wherein determining the one or more edges in each image in each octave level comprises:
determining that one or more respective strengths of the one or more edges satisfy an edge threshold.

19. The one or more non-transitory computer-readable storage media of claim 15, wherein identifying one or more circle feature points comprises:
identifying one or more candidate circle feature point using the Hough transform;
for each candidate circle feature point, determining whether a circle associated with the candidate circle feature point has a total number of supportive edge pixels that is greater than a threshold, the threshold being a function of a circumference length of the circle associated with the candidate circle feature point; and
selecting a candidate circle feature point that satisfies the threshold as one of the identified one or more circle feature points.

20. The one or more non-transitory computer-readable storage media of claim 15, wherein:
the descriptor for each point is determined based on a local patch; and
a size of the local patch is based on a radius of a circle associated with the identified circle feature point.
